(19) United States
(12) Patent Application Publication
(10) Pub. No.: US 2026/0170337 A1
(43) Pub. Date: Jun. 18, 2026

(54) BIOLOGICALLY INSPIRED SLEEP-LIKE OPTIMIZATION FOR NEURAL NETWORKS

(71) Applicant: THE REGENTS OF THE UNIVERSITY OF CALIFORNIA, Oakland, CA (US)

(72) Inventors: Jean Erik DELANOIS, San Diego, CA (US); Aditya AHUJA, San Francisco, CA (US); Giri P. KRISHNAN, Socorro, NM (US); Maksim BAZHENOV, San Diego, CA (US)

(21) Appl. No.: 18/981,304

(22) Filed: Dec. 13, 2024

Related U.S. Application Data
(63) Continuation-in-part of application No. 17/627,092, now Pat. No. 12,511,524.
(60) Provisional application No. 62/875,444, filed on Jul. 17, 2019.

(51) Int. Cl. G06N 3/082; G06N 3/048; G06N 3/049

(52) U.S. Cl. CPC G06N 3/082; G06N 3/048; G06N 3/049

(57) ABSTRACT

An example method of the presently disclosed technology may comprise: (1) transforming a neural network from a convolutional neural network (CNN) to a spiking neural network (SNN); (2) when the neural network is transformed into the SNN, modifying synaptic weights of the neural network by applying a simulated memory replay process to the neural network; and (3) after applying the simulated memory replay process to the neural network, transforming the neural network from the synaptic weight-modified SNN to a synaptic weight-modified CNN.

### STATEMENT REGARDING FEDERALLY SPONSORED R&D

This invention was made with government support under Grant No. 1R01MH125557 awarded by the National Institutes of Health (NIH), and Grant No. 2223839 awarded by the National Science Foundation (NSF). The government has certain rights in the Invention.

### TECHNICAL FIELD

The present disclosure is generally related to neural networks and machine learning. More specifically, some implementations relate to converting a convolutional neural network (CNN) into a spiking neural network (SNN) and simulating unsupervised replay in the SNN.

### DESCRIPTION OF RELATED ART

Over the past few decades, computer science has made remarkable advancements in the development of neural network models capable of performing intricate visual tasks. Deep learning, in particular, has played a pivotal role in driving this progress, with convolutional neural networks (CNNs) emerging as a significant breakthrough. Inspired by the structural characteristics of the human visual system, CNNs owe their success in large part to the introduction of convolutional layers. By combining convolutional and feedforward layers, deep networks have achieved state-of-the-art performance for classification and generative tasks.

### BRIEF DESCRIPTION OF THE DRAWINGS

Various embodiments are disclosed herein and described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates example images depicting distortions applied to a MNIST image classification data set used to test example algorithms, in accordance with various embodiments of the presently disclosed technology.

FIG. 2 illustrates example images depicting distortions applied to a CIFAR10 image classification data set used to test example Sleep Replay Consolidation (SRC) algorithms, in accordance with various embodiments of the presently disclosed technology.

FIG. 3 illustrates an example table that shows network parameters used for applying example SRC algorithms to the MNIST and CIFAR10 image classification data sets, in accordance with various embodiments of the presently disclosed technology.

FIG. 4 illustrates an example table that shows hyperparameters used for example SRC algorithms, in accordance with various embodiments of the presently disclosed technology.

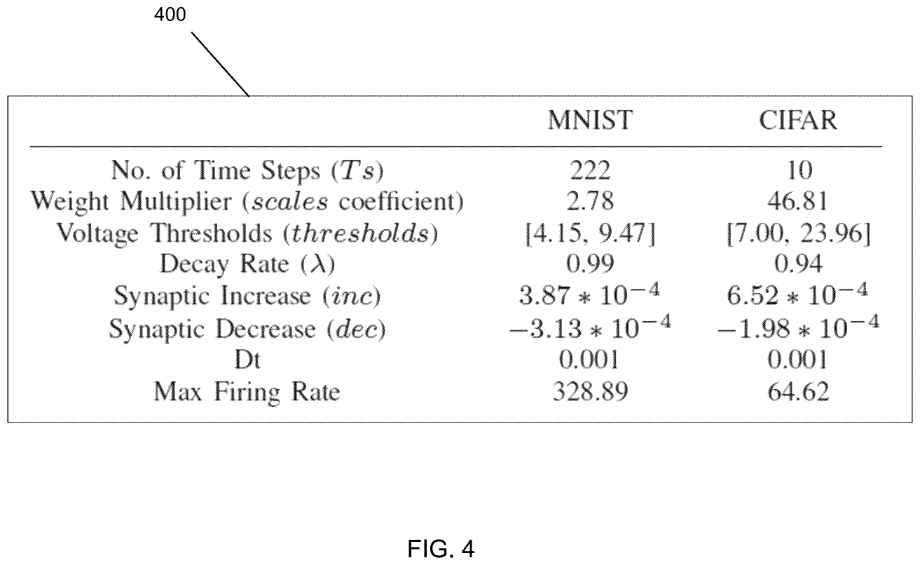

FIG. 5 illustrates example graphs depicting accuracy vs distortion intensity for different methods applied to the MNIST dataset, in accordance with various embodiments of the presently disclosed technology.

FIG. 6 illustrates example graphs depicting accuracy vs distortion intensity for different methods applied to the CIFAR10 dataset, in accordance with various embodiments of the presently disclosed technology.

FIG. 7 illustrates an example table showing model performance of various methods on the MNIST dataset, in accordance with various embodiments of the presently disclosed technology.

FIG. 8 illustrates an example table showing model performance of various methods on the CIFAR10 dataset, in accordance with various embodiments of the presently disclosed technology.

FIG. 9 illustrates an example table showing mean and standard deviation of spatial gradient variance across various models, in accordance with various embodiments of the presently disclosed technology.

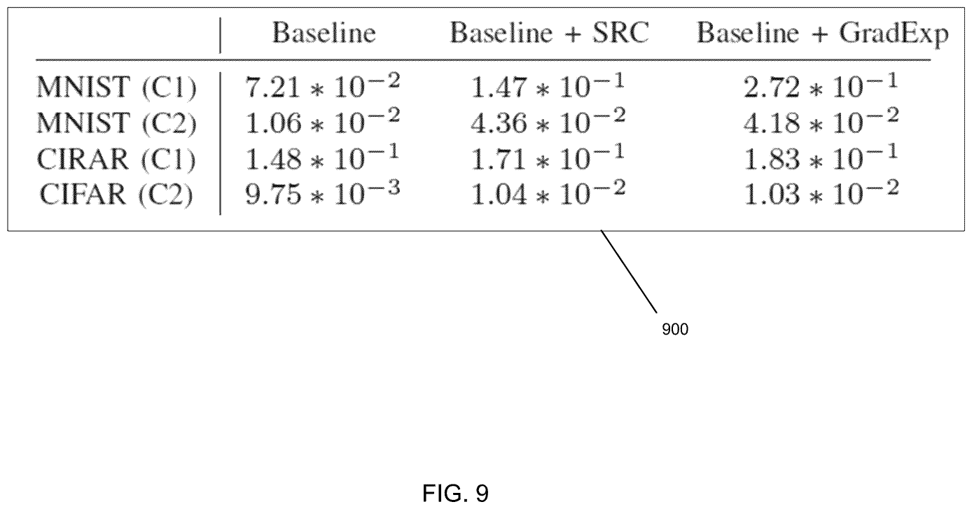

FIG. 10 illustrates an example table showing KL divergence values between a baseline and various models, in accordance with various embodiments of the presently disclosed technology.

FIG. 11 illustrates an example table showing Grad-CAM visualizations for the MNIST dataset that display the attention quality for a baseline and SRC, in accordance with various embodiments of the presently disclosed technology.

FIG. 12 illustrates example images depicting Grad-CAM visualizations for the CIFAR10 dataset that display the attention quality for a baseline and SRC, in accordance with various embodiments of the presently disclosed technology.

FIG. 13 illustrates example images depicting hyper parameters for Gradient expansion for results for the first and second convolution layer respectively, in accordance with various embodiments of the presently disclosed technology.

FIG. 14 illustrates an example table depicting Grad-CAM of the attention overlap metric for various methods, in accordance with various embodiments of the presently disclosed technology.

FIG. 15 illustrates an example algorithm for converting a CNN into an SNN and simulating unsupervised replay in the SNN, in accordance with various embodiments of the presently disclosed technology.

FIG. 16 illustrates an example method for converting a CNN into an SNN and simulating unsupervised replay in the SNN, in accordance with various embodiments of the presently disclosed technology.

FIG. 17 illustrates is an example computing component that may be used to implement various features of embodiments described in the present disclosure.

The figures are not exhaustive and do not limit the present disclosure to the precise form disclosed.

### DETAILED DESCRIPTION

As alluded to above, computer science has made remarkable advancements in the development of neural network models capable of performing intricate visual tasks. Deep learning, in particular, has played a pivotal role in driving this progress, with convolutional neural networks (CNNs) emerging as a significant breakthrough. Inspired by the structural characteristics of the human visual system, CNNs owe their success in large part to the introduction of convolutional layers. By combining convolutional and feedforward layers, deep networks have achieved state-of-the-art performance for classification and generative tasks.

However, despite their proven usefulness, convolutional filters have certain limitations. While the human visual system excels at accurately performing image-based tasks, even in the presence of substantial perturbations, CNNs trained using backpropagation-based methods can be highly sensitive to distortions. The impressive performance of these networks can quickly degrade when models operate in real-life applications and dynamic uncontrolled environments modify inputs with perturbations such as additive noise, blur, or other distortions (e.g., lighting, image quality, background, contrast, and perspective). This decrease in performance can be attributed to the perturbations degrading the quality of features that the convolutional layers are able to extract. Since the convolutional layers are trained on unperturbed (clean) images, they may be unable to extract useful features from distorted ones. Many existing methods for improving the robustness of convolutional filters involve explicit finetuning on predefined sets of perturbations or data augmentations. However, such supervised approaches generally require prior knowledge of the specific deformations or extensive training, meaning that these techniques can face challenges when limited data is available for fine-tuning or when unforeseen and untrained distortions are encountered in real-world scenarios. As a result, this can lead to a lack of generalization to out-of-distribution examples.

In contrast, biological systems have leveraged other mechanisms to improve memory representation and increase generalizability. Sleep has long been known to enhance learning in situations with limited experience, facilitate continuous learning, generalize knowledge acquired during wakefulness, and enable backward and forward transfer of knowledge. This functionality is prevalent and highly stereotyped in a variety of species ranging from insects to mammals. Two crucial components are believed to underlie the role of sleep in memory consolidation: (1) the spontaneous replay of memory traces in the absence of external input; and (2) local unsupervised synaptic plasticity that modifies synaptic weights. As embodiments of the presently disclosed technology are designed in appreciation of, applying sleep-like processing, such as Sleep Replay Consolidation (SRC), to fully connected feedforward networks can enhance continual learning during sequential task training and improve model robustness and generalizability.

While other biologically inspired approaches to enhance network generalizability to visual distortions exist, they often suffer from increased computational cost, lack dynamism, or require gathering expensive neural recordings or other hard to acquire data.

To address these limitations, systems and methods of the presently disclosed technology provide a novel approach that implements SRC in convolutional layers to provide a dynamic solution with low/reduced inference computation costs.

The presently disclosed SRC methodology can be implemented by transforming a neural network from a CNN to a spiking neural network (SNN) and simulating unsupervised replay in the transformed neural network (i.e., when the neural network is transformed into the SNN). This may involve: (a) replacing an original ReLU activation function of the CNN with a Heaviside function to gain a notion of spikes; (b) introducing input noise reflective of training data to induce network activity; and (c) applying local Hebbian-type plasticity rules to convolutional layers to modify synapses based on spiking patterns.

Advantages to the presently disclosed approach include improving robustness and generalization to noisy outputs, low/reduced computational costs (e.g., inference costs), and in some implementations, no need for prior knowledge of the type of input perturbation. By contrast, alternative biologically motivated methodologies can be more costly and fine-tuning such methodologies only improves performance on pre-defined augmentations.

### Data and Distortions

In accordance with example experiments, examples of the presently disclosed SRC models were evaluated using two well-known image classification data sets, MNIST and CIFAR-10, and further by incorporating standard distortions commonly encountered in both machine learning and real-world environments. These distortions included Gaussian blur, Additive Gaussian noise, Salt & pepper, and Speckle, with varying intensities.

MNIST consists of 60,000 28×28 monochromatic handwritten digits (0-9) while CIFAR-10 contains 60,000 32×32 color images of 10 classes (cars, birds, ships, etc.). Distortions were applied to the MNIST and CIFAR-10 data sets to test how different models, including examples of the presently disclosed SRC models, performed across the different distortions and varying intensities of the distortions.

As alluded to above, distortions applied to the data sets included Gaussian blur (GB), Additive Gaussian noise (GN), Salt and pepper (SP), and Speckle (SE).

Gaussian blur (GB) may involve convolving an input image with a Gaussian kernel with varying a values used to modify intensity. This type of distortion can be introduced when items present in the input image are in motion.

Additive Gaussian noise (GN) may refer to when noise drawn from a Gaussian distribution is added pixel-wise to the input image.

Salt and pepper (SP), also known as impulse noise, randomly selects input image pixels and sets them to either the minimum or maximum possible input value. The frequency of pixels may be selected to control intensity. This type of input noise can arise in digital images taken by cameras with faulty sensors.

Speckle (SE) may refer to a pixel-wise multiplicative noise where a random value is drawn from a Gaussian distribution and multiplied with an original pixel value to generate the new input values. Speckle noise is commonly a result of wave interference in images that are generated through the emission of specific frequencies of light, such as ultrasound and/or radar.

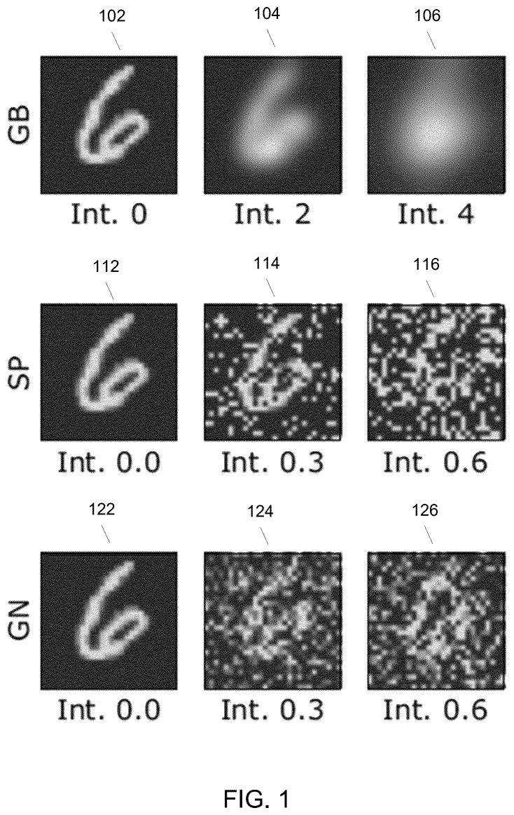

FIG. 1 shows visualizations via example images from MINST with various distortion types and intensity (Int.). Image 102 is a handwritten “six” with GB distortion applied at an intensity of 0. Image 104 shows the same handwritten “six” with GB distortion applied at an intensity of 2. Image 106 shows the same handwritten “six” with GB distortion applied at an intensity of 6.

Image 112 is a handwritten “six” with SP distortion applied at an intensity of 0.0. Image 114 shows the same handwritten “six” with SP distortion applied at an intensity of 0.3. Image 116 shows the same handwritten “six” with SP distortion applied at an intensity of 0.6.

Image 122 is a handwritten “six” with GN distortion applied at an intensity of 0.0. Image 124 shows the same handwritten “six” with GN distortion applied at an intensity of 0.3. Image 126 shows the same handwritten “six” with GN distortion applied at an intensity of 0.6.

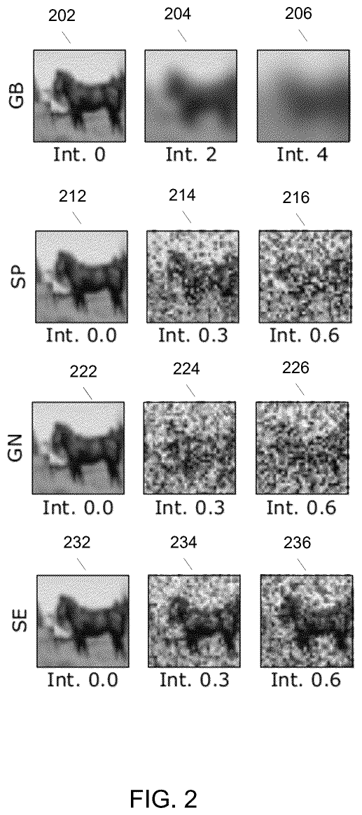

FIG. 2 shows visualizations via example images from CIFAR-10 with various distortions types and intensity (Int.). Image 202 is an image of horses in a field with GB distortion applied at an intensity of 0. Image 204 shows the image of horses in a field with GB distortion applied at an intensity of 2. Image 206 shows the same image of horses in a field with GB distortion applied at an intensity of 4.

Image 212 is an image of horses in a field with SP distortion applied at an intensity of 0.0. Image 214 shows the same image of horses in a field with SP distortion applied at an intensity of 0.3. Image 216 shows the same image of horses in a field with SP distortion applied at an intensity of 0.6.

Image 222 is an image of horses in a field with GN distortion applied at an intensity of 0.0. Image 224 shows the same image of horses in a field with SP distortion applied at an intensity of 0.3. Image 226 shows the same image of horses in a field with SP distortion applied at an intensity of 0.6.

Image 232 is an image of horses in a field with SP distortion applied at an intensity of 0.0. Image 234 shows the same image of horses in a field with SP distortion applied at an intensity of 0.3. Image 236 shows the same image of horses in a field with SP distortion applied at an intensity of 0.6.

As depicted in FIG. 1 and FIG. 2, the application of distortion to images at increased intensity makes recognition of the images more difficult, not only for humans but also for neural network models. Some distortions make image recognition more difficult than others. For example, distortions such as brightening/darkening may yield miniscule degradation in performance. As a result, for any image recognition training of neural networks, distortions that cause significant decline in accuracy for the baseline model are often selected. For image recognition training of neural networks distortion values may be clamped to keep the inputs for the model in a reasonable range.

### Models

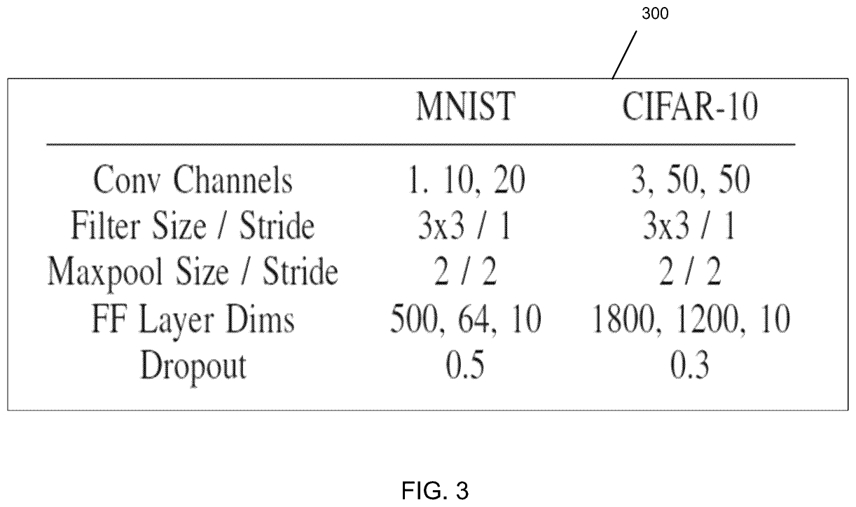

In an effort to generate interpretable results, the example experiments utilized smaller, more simple models with the goal of improving transparency and understandability of the underlying mechanisms. For MNIST, a four-layer CNN consisting of two convolutional and two feedforward layers was used. Both convolutional layers leveraged 3×3 filters with a stride of one, no padding, and a ReLU activation. Each filter bank had 1/10 input channels and 10/20 output channels respectively. After each convolution there was a maxpool with a window size and stride of two. The feedforward layers received an input that matched the output size of the convolutional layers (500) followed by a hidden layer of size 64 with an output size of 10. The hidden layer leveraged a ReLU activation function and dropout during training with a rate of 0.5. The CIFAR model was of a similar structure with the only differences being the number of channels in the convolutional layers which was increased to 3/50 and 50/50 and the size of the feedforward portion of the network receiving a 1800 dimensional vector as an input with a 1200 dimensional hidden layer, the output was kept to 10 units. All layers present, both feedforward and convolutional, omitted bias terms to allow for a standard conversion to a spiking neural network, this did not notably impact the overall performance of these networks. Model parameters are for the CNNs are depicted in table 300 of FIG. 3.

### Sleep Replay Consolidation (SRC)

An SRC process of the presently disclosed technology may first involve transforming a neural network from a CNN to an SNN. When the neural network is transformed into the SNN, the SRC process may involve modifying synaptic weights of the neural network by applying a simulated memory replay process to the neural network, during which unsupervised synaptic modifications may occur. After applying the simulated memory replay process to the neural network, the SRC process may involve transforming the neural network from the synaptic weight-modified SNN to a synaptic weight-modified CNN. The synaptic weight-modified CNN may then be used in a CNN forward pass.

In certain embodiments, original network structure may be preserved when transforming the neural network from the CNN to the SNN. A membrane potential (e.g., a voltage) may be simulated for each node/neuron in the neural network. A respective voltage/membrane potential may be comprised of a running sum of inputs determined by presynaptic activity combined with the input weights and may be subject to decay, effectively simulating dynamics of a leaky integrate and fire neuron. A ReLU activation may be swapped for a Heaviside function to develop a notion of spikes. Once a neuron's membrane potential surpasses the given threshold, the neuron may emit a spike and the voltage can be reset to 0. To ensure that activity propagates across layers, layer wise scale factors to synaptic weights may be generated in accordance with different data-based normalization techniques and may be further multiplied by a hyperparameter coefficient. These modifications can be applied to convolutional layer neurons, successfully converting CNN to SNN, while preserving network architecture and synaptic weight structure.

During the sleep phase, the SNN's activity may be driven by a randomly distributed Poisson spiking input with firing rates determined by the average values of each input pixel activation from a training data set. Hebbian style learning rules can be applied to modify the weights. For example, a weight may be increased between two nodes when both pre- and post-synaptic nodes are activated and a weight may be decreased when the post-synaptic node is activated but the pre-synaptic node is not. After this unsupervised sleep period has been executed, the CNN model can be restored by eliminating the simulated voltage, removing scale factors, and restoring the original activation functions.

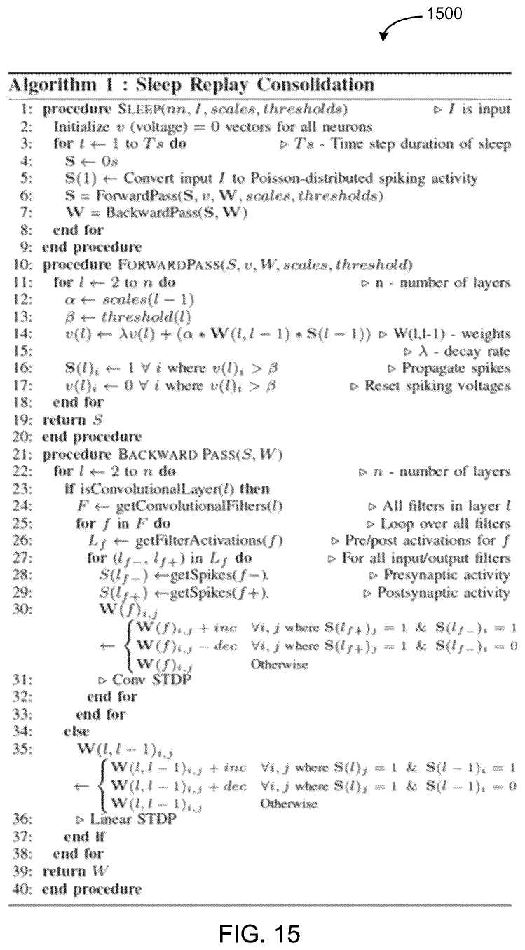

An example pseudo-code algorithm 1500 for the above-described SRC process is depicted in FIG. 15.

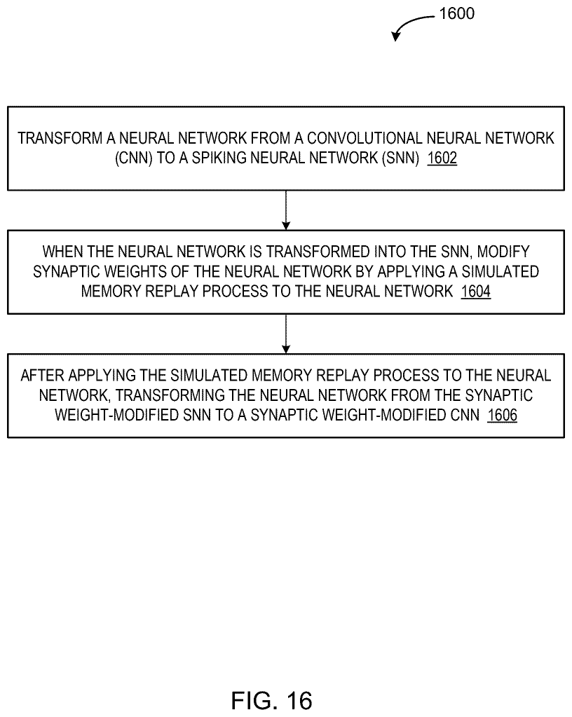

FIG. 16 illustrates an example method 1600 in accordance with the presently disclosed SRC process described above.

As depicted, operation 1602 may involve transforming a neural network from a convolutional neural network (CNN) to a spiking neural network (SNN). In some of such implementations, transforming the neural network from the CNN to the SNN may comprise preserving the (same) network architecture (e.g., neuron and synaptic weight architecture) for the neural network.

In various implementations (and as described above), transforming the neural network from the CNN to the SNN may comprise: (a) simulating a membrane potential for each neuron of the neural network; (b) replacing an original activation function of the neural network with a Heaviside function to facilitate spikes such that when the simulated membrane potential of a respective neuron surpasses a pre-determined threshold, the respective neuron emits a spike; and (c) applying layer-wise scale factors to the synaptic weights of the neural network to facility activity across all layers of the neural network.

In certain implementations (and as described above), the simulated membrane potential for the respective neuron may comprise a voltage reflecting a running sum of inputs determined by synaptic activity preceding the respective neuron in the neural network combined with synaptic weights preceding the respective neuron in the neural network. Here (and as described above), the simulated membrane potential for the respective neuron may be subject to decay to simulate dynamics of a leaky integrate and neuron fire. In some implementations, simulating the membrane potential for each neuron of the neural network may comprise resetting the membrane potential for the respective neuron to a zero value when the respective neuron emits a spike.

In various implementations (and as described above), applying the layer-wise scale factors to the synaptic weights of the neural may comprise generating a respective layer-wise scale factor in accordance with a data-based normalization technique and multiplication with a hyperparameter coefficient.

In some implementations (and as described above), the (replaced) original activation function of the neural network may comprise a ReLU activation function.

As depicted in FIG. 16, when the neural network is transformed into the SNN, operation 1604 may involve modifying synaptic weights of the neural network by applying a simulated memory replay process to the neural network.

In some implementations (and as described above), modifying the synaptic weights of the neural network by applying the simulated memory replay process to the neural network may comprise applying a randomly distributed spiking input to the neural network and applying Hebbian-based learning rules to modify the synaptic weights. In certain of these implementations, the randomly distributed spiking input may comprise a randomly distributed Poisson spiking input with firing rates determined by average values of each input pixel of a training dataset. Relatedly, the Hebbian-based learning rules may comprise: (i) increasing a respective synaptic weight connecting a first neuron to a second neuron when both the first and second neuron are activated, wherein the first neuron is a pre-synaptic connection neuron and the second neuron is a post-synaptic connection neuron; and (ii) decreasing the respective synaptic weight when the second neuron is activated and the first neuron is not activated.

As depicted in FIG. 16, after applying the simulated memory replay process to the neural network, operation 1606 may involve transforming the neural network from the synaptic weight-modified SNN to a synaptic weight-modified CNN.

In various implementations, transforming the neural network from the synaptic weight-modified SNN to the synaptic weight-modified CNN may comprise: (a) removing the simulated membrane potentials from the neural network; (b) removing the layer-wise scale factors from the neural network; and (c) replacing the Heavyside function with the original activation function for the neural network.

In various implementations, the above-described approach can be directly applied to a fully connected network since it produces one-to-one mapping from any pair of pre and post activations to the corresponding synaptic weights. However, implementing this to convolutional layers can be more complicated. Because of parameter sharing, a single synaptic weight may take part in multiple synaptic events. Thus, based on the network activity, the same set of synaptic weights may need to be updated multiple times during a single iteration of SRC, thus accumulating synaptic updates over all activations that are associated to a given convolutional weight for every iteration. The SRC hyperparameters may be selected through the use of a standard python Genetic Algorithm implementation tasked to optimize mean validation performance over different types of distortions.

### Experimental Design

In testing neural networks, it is important that all models tested undergo standard training protocol to ensure accuracy and reliability of results. For example, in accordance with example embodiments, native MNIST and CIFAR-10 models may be trained for 50 epochs with a learning rate of 0.01/0.3 on the undistorted data set until a steady performance is achieved. Additionally, a binary cross entropy loss function along with a standard stochastic gradient decent optimizer may be utilized to alter model parameters. Following baseline training models may undergo periods of SRC and subsequent Feedforward Fitting.

Testing according to example embodiments may be repeated a number of times, e.g. 10 trials, with each of the trials receiving a unique random seed, which results in differences in model weight initialization, training sample order, and SRC input noise generation.

### Results

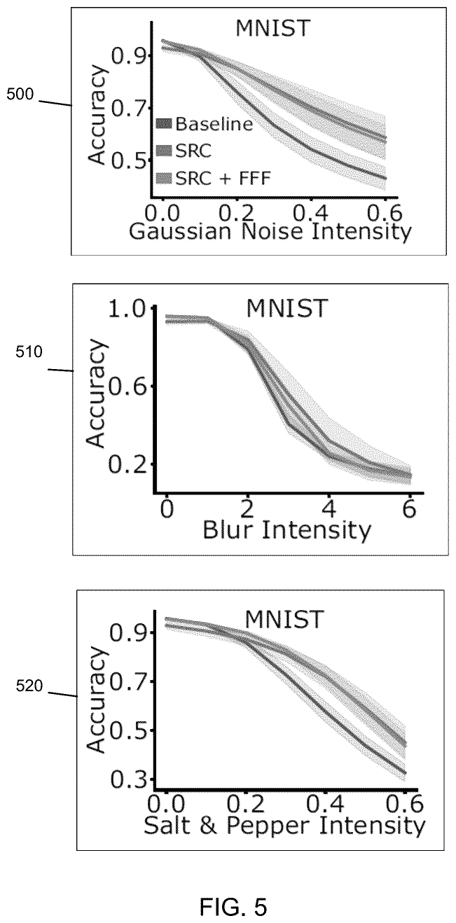

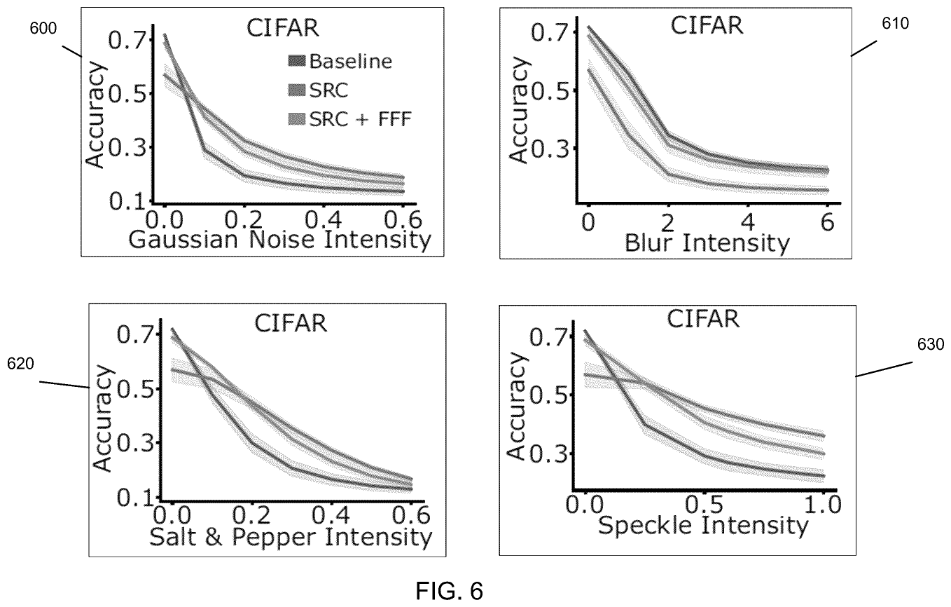

FIG. 5 and FIG. 6 show test results from a ten trial test using a baseline CNN model comprised of two convolutional and two feedforward layers according to example embodiments. To establish a baseline model, a model was trained on clean unperturbed images until a plateaued mean performance of roughly 95% for MNIST and 70% for CIFAR-10 accuracy on an undistorted data set was achieved. After achieving a sufficient baseline model, the baseline model can be tested across a variety of distortions.

According to one embodiment, after establishing the baseline, SRC may be applied to exclusively to the conventional layers, and performance is tested above using another ten trial test. This type of testing can be applied to both MNIST and CIFAR-10, additionally, different distortions can also be applied to test the performance of SRC.

According to another embodiment, another training stage can be implemented that such that the training involves SRC and Feedforward Fitting (“FFF”). This type of testing may include the feedforward head of the network undergoing minimal training on the undistorted training data set with labels or features, or both, being extracted by frozen convolutional weights that are used to perform backpropagation on the feedforward layers only. As a result, the process can be adjust the decision making head of the network to the newly developed feature extractors formed after SRC. FFF may be applied until training set performance is saturated.

FIG. 5 shows the results of image recognition for MNIST, with different distortions applied, of ten trial tests for each of a baseline model, a SRC model, and a SRC+FFF model according to example embodiments. The results show the accuracy of each respective model as the intensity of a particular blur is increased, the lines of the graphs represent the mean across the trials while the shaded regions surrounding each line represents the standard deviation across the trials. Graph 500 shows the results for ten trial test of each of a baseline model, and SRC model, and a SRC+FFF model for MNIST with Gaussian Noise distortion applied. Graph 510 shows the results for ten trial test of each of a baseline model, and SRC model, and a SRC+FFF model for MNIST with Blur distortion applied. Graph 520 shows the results for ten trial test of each of a baseline model, and SRC model, and a SRC+FFF model for MNIST with a Salt and Pepper distortion applied.

FIG. 6 shows the results of image recognition for CIFAR-10, with different distortions applied, of ten trial tests for each of a baseline model, a SRC model, and a SRC+FFF model according to example embodiments. The results show the accuracy of each respective model as the intensity of a particular blur is increased, the lines of the graphs represent the mean across the trials while the shaded regions surrounding each line represents the standard deviation across the trials. Graph 600 shows the results for ten trial test of each of a baseline model, and SRC model, and a SRC+FFF model for CIFAR-10 with Gaussian Noise distortion applied. Graph 610 shows the results for ten trial test of each of a baseline model, and SRC model, and a SRC+FFF model for CIFAR-10 with Blur distortion applied. Graph 620 shows the results for ten trial test of each of a baseline model, and SRC model, and a SRC+FFF model for CIFAR-10 with a Salt and Pepper distortion applied. Graph 630 shows the results for ten trial test of each of a baseline model, and SRC model, and a SRC+FFF model for CIFAR-10 with a Speckle distortion applied.

The test results shown in FIG. 5 and FIG. 6 show that the SRC and SRC+FFF outperform the baseline model in the tests for all but one of the types of distortions applied. More specifically, for larger distortion intensity values, the SRC model improved performance up to about 15% for MNIST and 10% for CIFAR-10. The test results also show improvement in performance on heavily distorted inputs following SRC. Additionally, the SRC+FFF model regained some of the lost performance on the minimally distorted data sets while significantly maintaining the performance gained for higher distortions.

A classic machine learning approach to gain model performance on new data distributions is fine-tuning (“FT”). Fine tuning, while being an effective paradigm requires foresight of specific potential data perturbations and additional time to train the model, nonetheless it remains a leading benchmark for accuracy of neural network models. Accordingly neural network models are often compared to the standard supervised method of fine tuning.

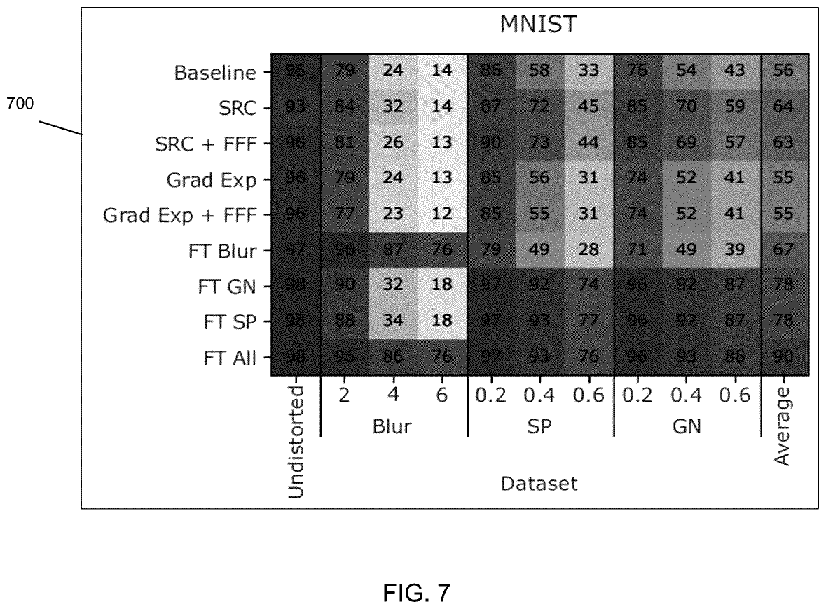

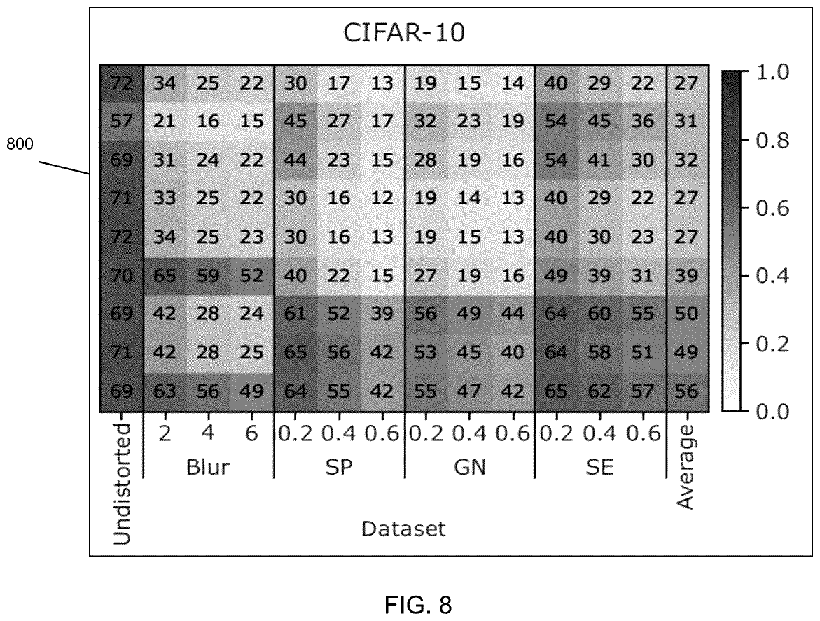

FIG. 7 and FIG. 8 show the model performance for various models, including a baseline model, standard fine tuning models, and models according to embodiments such as SRC and SRC+FFF. In comparing the different models, fine-tuned models specialized in each specific distortion were developed. Specifically, the fine-tuned models were initialized using weights from the model trained on undistorted data, and subsequently underwent 10 additional epochs of training (with learning rates of 0.05/0.15 for MNIST/CIFAR-10) using the specialized data set comprised of the undistorted data combined with varying levels of distortion from their expertise. To compare model performance of the different models, the average accuracy of each model across ten trials was collected.

Graph 700 shows the results of the model performance for MNIST of a baseline model, an SRC model, a SRC+FFF model, a Gradient Expansion model, a Gradient Expansion+FFF model, a FT Blur model, a FT GN model, a FT SP model, and a FT All model. Each model underwent a ten trial test for each of an undistorted MNIST dataset, the MNIST dataset with a blur distortion applied at three different intensities, the MNIST dataset with a SP distortion applied at three different intensities, and the MNIST dataset with a GN distortion applied at three different intensities. Graph 700 also shows the average accuracy of all of the tests for each model.

Graph 800 shows the results of the model performance for CIFAR-10 of a baseline model, an SRC model, a SRC+FFF model, a Gradient Expansion model, a Gradient Expansion+FFF model, a FT Blur model, a FT GN model, a FT SP model, and a FT All model. Each model underwent a ten trial test for each of an undistorted CIFAR-10 dataset, the CIFAR-10 dataset with a blur distortion applied at three different intensities, the CIFAR-10 dataset with a SP distortion applied at three different intensities, the CIFAR-10 dataset with a GN distortion applied at three different intensities, and the CIFAR-10 dataset with a SE blur at three different intensities. Graph 800 also shows the average accuracy of all of the tests for each model.

The results shown in FIG. 7 and FIG. 8, show that SRC models may have a performance ceiling as compared to the traditional fine-tuned model for specific distortions. While fine-tuning on a specific distortion lead to improved performance on that corresponding perturbation the results also show no significant increase, or even a decline, in performance on other distortions. For example, for the MNIST model fine-tuned on blur which achieved optimal blur performance ranging from 96%-76% across corresponding blur intensities 2 to 6, while performance on different distortions was below the baseline. Interestingly, when the MNIST model was fine-tuned on GN or SP, there was a remarkable degree of transfer learning to other distortions; all fine-tuned models for CIFAR-10 also demonstrated this high degree of transfer. The FT models may have been the most accurate models for their respective domain (e.g. the FT Blur performed best for that distortion), however, the SRC model outperformed the FT models on untrained distortions where there was little transfer learning. So while FT models may have improved performance for the specific distortion they are fine tuned for, this can only be achieved with a significantly higher degree of training. For example, the specialized FT models required at least ten epochs on a fine tuning data set that contained seven times the number of training examples as in the original training set (one partition undistorted and 6 partitions of varying degrees of distortions). As a result, at least one particular advantage of SRC models is that they provide a more efficient approach for increasing model robustness when specifics of anticipated distortions are unknown, which is likely to be the case in many “real-world” applications of neural network models, not only for image recognition but for a wide variety of goals and tasks.

The spatial gradient of convolutional filters may be examined and can be used as a metric for filter quality. For example, by inspecting the quality of filters across all convolutional blocks in the network the quality of the CNN can be determined. One way to achieve this is by taking the pixel-wise spatial gradient of all filters in a given layer and fit a Gaussian probability distribution to their values, creating a probabilistic representation for the filter gradients in each convolutional layer. This type of weight analysis can be applied to the convolutional filters of an SRC model according to example embodiments to further investigate and understand why the SRC improves model performance. By examining the properties, such as but not limited to the variance, of the Gaussian probability distribution, to understand the estimated quality of the convolutional blocks. For example, a narrow distribution may indicate many repeated filters while a wider distribution may indicate a large variety of filters. The variability may enable rich feature extraction that may be beneficial for classification.

Table 900 shows the standard deviation of spatial gradient variance across a baseline model, a Baseline+SRC model, and a Baseline+Gradient Expansion (“GradExp”) model. Furthermore, Table 900 shows the results for the first convolution layer (C1) and the second convolution layer (C2), respectively. Both the SRC and GradExp models increase variance of the spatial gradient, however, only the SRC model showed a performance increase as well. This may indicate that SRC models produce more diverse and robust feature extractors through local activation patterns within the network and which may be one of the reasons why sleep-like replay is capable of improving model performance across distortions.

Further tests may be performed to further examine the effect filter spatial gradient magnitude variance has on model performance. For example, the spatial gradients of convolutional filters from the baseline model can be artificially expanded to approximate distribution of those in the SRC model. This can be done by choosing a set of hyperparameters (α₁, . . . , α_{L}) and increase the absolute value of all filter elements by that amount. To account for layer specific weigh statistics, different α₁ values for each layer can be selected to approximate changes observed following SRC:

$$W ( l ) = \{ \begin{matrix}W ( l ) + {α}_{l} , & if W ( l ) \\ W ( I ) - {α}_{l} , & otherwise\end{matrix} .$$

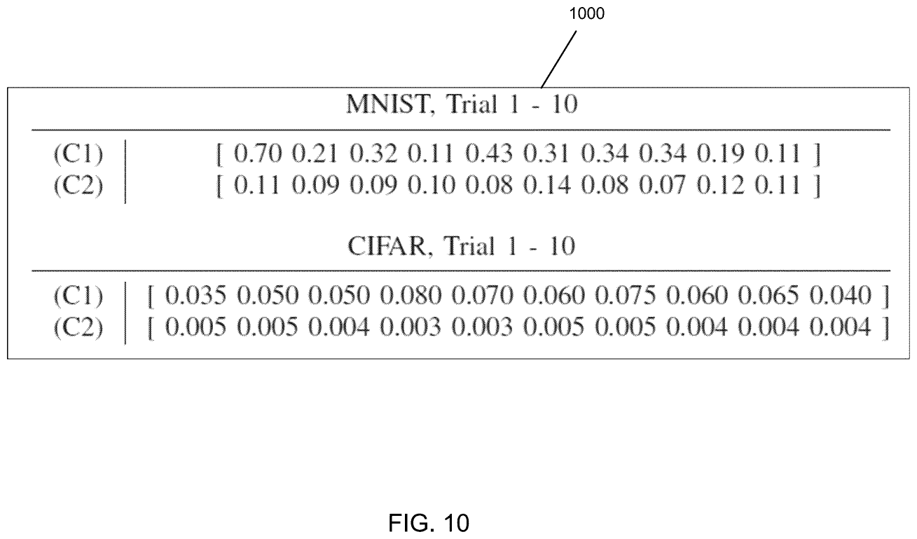

FIG. 10 shows Table 1000 that lists the hyperparameters from 10 random trials each for MNIST and CIFAR-10. Once again C1 and C2 refer to results for the first and second convolution layer respectively.

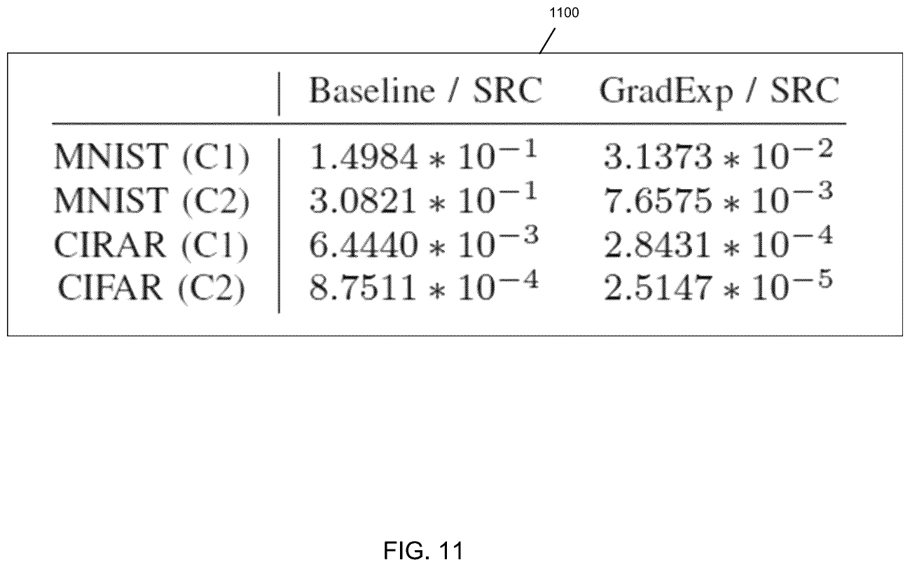

Another test, that can be used to ensure that the increase of hyperparameters generates Gradient Expansion models have different spatial gradient distributions from our baseline model yet are similar to SRC models. This test may measure the KL divergence of the convolutional filter's spatial gradient distributions for baseline vs. SRC and SRC vs. GradExp models. Table 1100 of FIG. 11 shows example KL divergence values between the baseline and SRC models, as well as the GradExp and SRC models, according to example embodiments. C1 and C2 refer to the results for the first and second convolution layers respectively. Table 1100 shows a relatively high KL divergence between the baseline and SRC, which may signify that SRC is meaningfully modifying filters, and conversely, a relatively low KL divergence between SRC and GradExp models may indicate that the artificially generated spatial gradients are statistically similar to those achieved through SRC.

Different versions of gradient models can be tested across distortion intensities for both MNIST and CIFAR-10. For example, a test may expand convolutional filter gradients exclusively, whereas a second may apply Feedforward Fitting (FFF) to the network head following filter gradient expansion to allow the decision layers to acclimate to the new feature extractors.

Another way to gain a deeper qualitative and quantitative understanding of how SRC may impact a network, is to analyze the performance of the model by utilizing Gradient-weighted Class Activation Mapping (Grad-CAM). Grad-CAM is a visualization technique that creates an attention map for a given input to identify what the network focuses on. It operates by supplying an image as input and performing a forward pass followed by the calculation of gradients with respect to a given output label. Gradient values can then be used to weight final convolutional activations (which maintain their spatial relevance), the intuition being more important features will have higher gradient values. This approach develops a notion of what input regions the network is attending to.

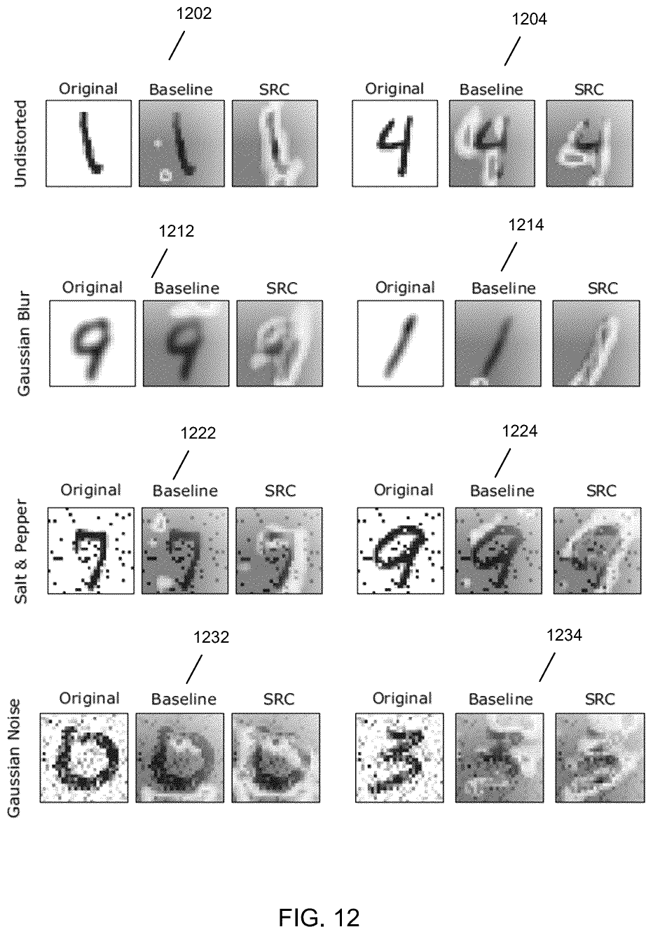

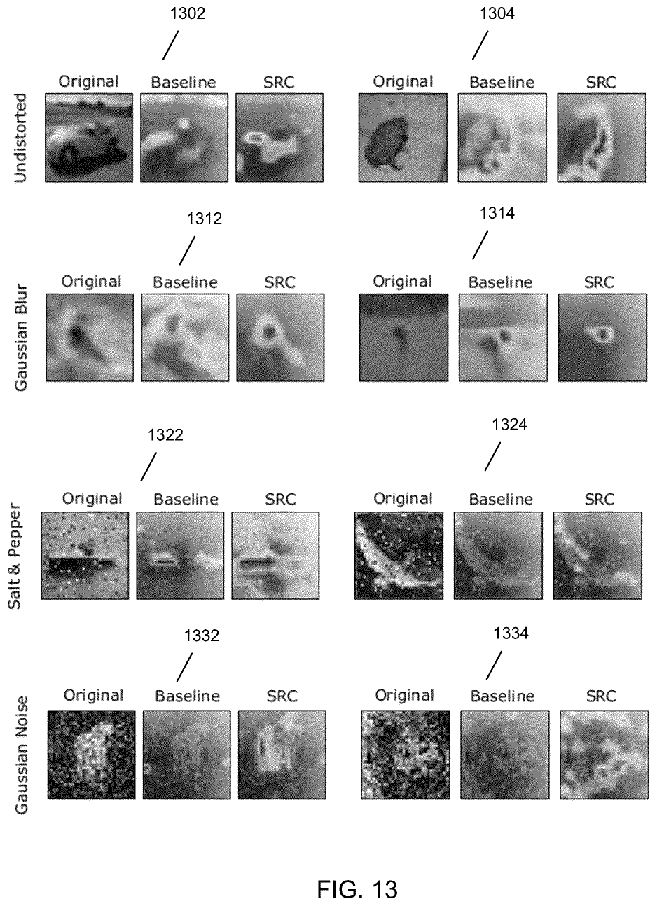

FIG. 12 and FIG. 13 show Grad-CAM visualizations that enable the observation of improvements in attention as a result of SRC. FIG. 12 shows original MNIST images as well as the Grad-CAM visualizations for different models for when the MNIST is undistorted and when different distortions are applied. Image 1202 shows an undistorted MNIST image and the Grad-CAM visualizations of the baseline model and a SRC model. Similarly, image 1204 shows an undistorted MNIST image and the Grad-CAM visualizations of the baseline model and a SRC model. Image 1212 shows a MNIST image with a blur distortion applied and the Grad-CAM visualizations of the baseline model and a SRC model. Image 1214 shows a MNIST image with a blur distortion applied and the Grad-CAM visualizations of the baseline model and a SRC model. Image 1222 shows a MNIST image with a salt and pepper distortion applied and the Grad-CAM visualizations of the baseline model and a SRC model. Image 1224 shows a MNIST image with a salt and pepper distortion applied and the Grad-CAM visualizations of the baseline model and a SRC model. Image 1232 shows a MNIST image with a gaussian noise distortion applied and the Grad-CAM visualizations of the baseline model and a SRC model. Image 1234 shows a MNIST image with a gaussian noise distortion applied and the Grad-CAM visualizations of the baseline model and a SRC model. The results depicted in FIG. 12 display that SRC improves attention quality over the baseline model for performance for MNIST datasets, even when different distortions are applied.

FIG. 13 shows original CIFAR-10 images as well as the Grad-CAM visualizations for different models for when the CIFAR-10 is undistorted and when different distortions are applied. Image 1302 shows an undistorted CIFAR-10 image and the Grad-CAM visualizations of the baseline model and a SRC model. Similarly, image 1304 shows an undistorted CIFAR-10 image and the Grad-CAM visualizations of the baseline model and a SRC model. Image 1313 shows a CIFAR-10 image with a gaussian blur distortion applied and the Grad-CAM visualizations of the baseline model and a SRC model. Image 1314 shows a CIFAR-10 image with a gaussian blur distortion applied and the Grad-CAM visualizations of the baseline model and a SRC model. Image 1322 shows a CIFAR-10 image with a salt and pepper distortion applied and the Grad-CAM visualizations of the baseline model and a SRC model. Image 1324 shows a CIFAR-10 image with a salt and pepper distortion applied and the Grad-CAM visualizations of the baseline model and a SRC model. Image 1332 shows a CIFAR-10 image with a gaussian noise distortion applied and the Grad-CAM visualizations of the baseline model and a SRC model. Image 1334 shows a CIFAR-10 image with a gaussian noise distortion applied and the Grad-CAM visualizations of the baseline model and a SRC model. The results depicted in FIG. 13 display that SRC improves attention quality over the baseline model for performance for CIFAR-10 datasets, even when different distortions are applied. FIG. 12 and FIG. 13 show that in both the MNIST and CIFAR contexts, the SRC model was able to better overlap with the original image input as compared to the baseline model, which often attended to seemingly random pixels. Importantly, is that this improvement of performance of the SRC model was observed not only for the undistorted images but also for the imaged with different distortions applied. The SRC model was able to cut through with the attention heat map taking the shape of the original digit, which indicates that the network is focusing on the relevant features as opposed to irrelevant noise.

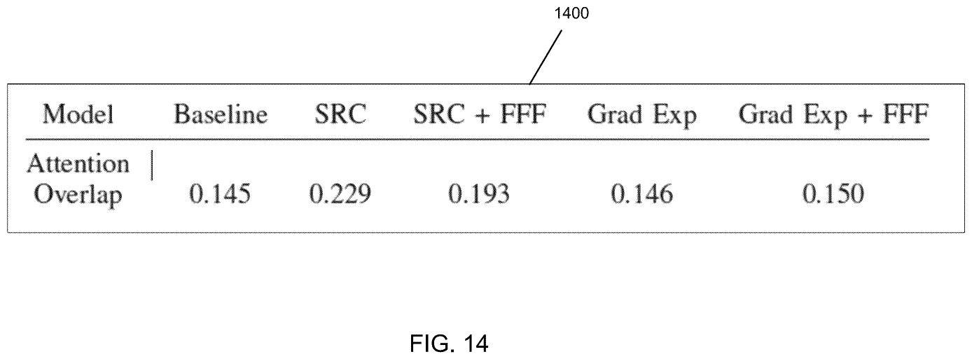

The results of the attention improvements can be quantified in different ways, for example, a rudimentary metric may be constructed in which a pixel wise map of the original digit is developed where 1's are assigned to input locations that correspond with nonzero pixel value and O's everywhere else which may be followed by a cosine similarity between the mask and the attention vector output by Grad-CAM. With this type of metric, Values close to 1 indicate a large overlap between the clean input image and the network's attention while values near 0 signify a misplaced network focus. Further, this metric may be averaged across different trials of models where different distortion/intensity combinations were applied. Applying this type of metric to the tests described that used example embodiments, the amount of attention overlap and the original undistorted input digit was significantly higher for the model that underwent SRC when compared to the baseline or GradExp models. This indicates that the nontrivial selective filter gradient enhancement provided by SRC can improve convolutional filter quality and focus, even in the presence of meaningful perturbation, which increased overall model performance as compared to at least baseline and GradExp models. Table 1400 in FIG. 14 shows an exemplary Grad-CAM attention overlap metric for different models including SRC models according to example embodiments. Table 1400 shows that the SRC models (both SRC and SRC+FFF) metric values are closer to 1 than are the other models (baseline, Grad Exp, and Grad Exp+FFF). Models that utilize SRC not only increase attention overlap as compared to baseline, but also do so while offering increased performance over other models such as GradExp models.

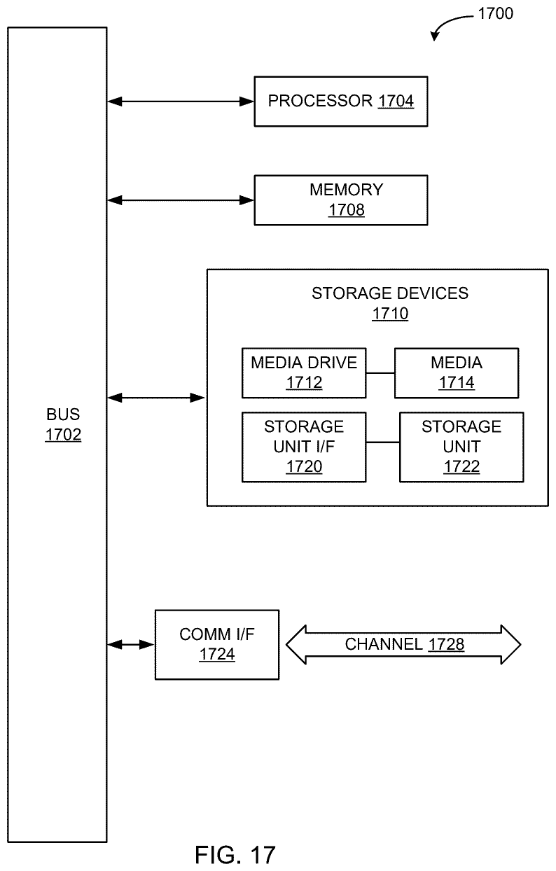

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 17. Various embodiments are described in terms of this example-computing component 1700. After reading this description, it will become apparent to a person skilled in the relevant art how to implement the application using other computing components or architectures.

Referring now to FIG. 17, computing component 1700 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1700 might also represent computing capabilities embedded within or otherwise available to a given device. For example, a computing component might be found in other electronic devices such as, for example, portable computing devices, and other electronic devices that might include some form of processing capability.

Computing component 1700 might include, for example, one or more processors, controllers, control components, or other processing devices. This can include a processor, and/or any one or more of the components making up a user device, a user system, and a non-decrypting cloud service. Processor 1704 might be implemented using a general-purpose or special-purpose processing engine such as, for example, a microprocessor, controller, or other control logic. Processor 1704 may be connected to a bus 1702. However, any communication medium can be used to facilitate interaction with other components of computing component 1700 or to communicate externally.

Computing component 1700 might also include one or more memory components, simply referred to herein as main memory 1708. For example, random access memory (RAM) or other dynamic memory, might be used for storing information and instructions to be executed by processor 1704. Main memory 1708 might also be used for storing temporary variables or other intermediate information during execution of instructions to be executed by processor 1704. Computing component 1700 might likewise include a read only memory (“ROM”) or other static storage device coupled to bus 1702 for storing static information and instructions for processor 1704.

The computing component 1700 might also include one or more various forms of information storage mechanism 1710, which might include, for example, a media drive 1712 and a storage unit interface 1720. The media drive 1712 might include a drive or other mechanism to support fixed or removable storage media 1714. For example, a hard disk drive, a solid-state drive, a magnetic tape drive, an optical drive, a compact disc (CD) or digital video disc (DVD) drive (R or RW), or other removable or fixed media drive might be provided. Storage media 1714 might include, for example, a hard disk, an integrated circuit assembly, magnetic tape, cartridge, optical disk, a CD or DVD. Storage media 1714 may be any other fixed or removable medium that is read by, written to or accessed by media drive 1712. As these examples illustrate, the storage media 1714 can include a computer usable storage medium having stored therein computer software or data.

In alternative embodiments, information storage mechanism 1710 might include other similar instrumentalities for allowing computer programs or other instructions or data to be loaded into computing component 1700. Such instrumentalities might include, for example, a fixed or removable storage unit 1722 and interface 1720. Examples of such storage units 1722 and interfaces 1720 can include a program cartridge and cartridge interface, a removable memory (for example, a flash memory or other removable memory component) and memory slot. Other examples may include a PCMCIA slot and card, and other fixed or removable storage units 1722 and interfaces 1720 that allow software and data to be transferred from storage unit 1722 to computing component 1700.

Computing component 1700 might also include a communications interface 1724. Communications interface 1724 might be used to allow software and data to be transferred between computing component 1700 and external devices. Examples of communications interface 1724 might include a modem or softmodem, a network interface (such as Ethernet, network interface card, IEEE 802.XX or another interface). Other examples include a communications port (such as for example, a USB port, IR port, RS232 port Bluetooth® interface, or other port), or other communications interfaces. Software/data transferred via communications interface 1724 may be carried on signals, which can be electronic, electromagnetic (which includes optical) or other signals capable of being exchanged by a given communications interface 1724. These signals might be provided to communications interface 1724 via a channel 1728. Channel 1728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 1708, storage unit 1720, media 1714, and channel 1728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1700 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
transforming a neural network from a convolutional neural network (CNN) to a spiking neural network (SNN);
when the neural network is transformed into the SNN, modifying synaptic weights of the neural network by applying a simulated memory replay process to the neural network; and
after applying the simulated memory replay process to the neural network, transforming the neural network from the synaptic weight-modified SNN to a synaptic weight-modified CNN.

2. The method of claim 1, wherein transforming the neural network from the CNN to the SNN comprises:
simulating a membrane potential for a respective neuron of the neural network; and
replacing an original activation function of the neural network with a Heaviside function to facilitate spikes such that when the simulated membrane potential for the respective neuron surpasses a pre-determined threshold, the respective neuron emits a spike.

3. The method of claim 2, wherein the simulated membrane potential for the respective neuron comprises a voltage reflecting a running sum of inputs determined by synaptic activity preceding the respective neuron in the neural network combined with synaptic weights preceding the respective neuron in the neural network.

4. The method of claim 3, wherein the simulated membrane potential for the respective neuron is subject to decay to simulate dynamics of a leaky integrate and neuron fire.

5. The method of claim 2, wherein simulating the membrane potential for the respective neuron comprises:
resetting the membrane potential for the respective neuron to a zero value when the respective neuron emits a spike.

6. The method of claim 2, wherein transforming the neural network from the CNN to the SNN further comprises:
applying layer-wise scale factors to the synaptic weights of the neural network to facility activity across all layers of the neural network.

7. The method of claim 6, wherein applying the layer-wise scale factors to the synaptic weights of the neural network comprises generating a respective layer-wise scale factor in accordance with a data-based normalization technique and multiplication with a hyperparameter coefficient.

8. The method of claim 1, wherein transforming the neural network from the CNN to the SNN comprises preserving a network architecture of the neural network.

9. The method of claim 2, wherein the original activation function of the neural network comprises a ReLU activation function.

10. The method of claim 1, wherein modifying the synaptic weights of the neural network by applying the simulated memory replay process to the neural network comprises:
applying a randomly distributed spiking input to the neural network and applying Hebbian-based learning rules to modify the synaptic weights.

11. The method of claim 10, wherein:
the randomly distributed spiking input comprises a randomly distributed Poisson spiking input with firing rates determined by average values of each input pixel of a training dataset.

12. The method of claim 10, wherein the Hebbian-based learning rules comprise:
increasing a respective synaptic weight connecting a first neuron to a second neuron when both the first and second neuron are activated, wherein the first neuron is a pre-synaptic connection into the respective synaptic weight and the second neuron is a post-synaptic connection from the respective synaptic weight; and
decreasing the respective synaptic weight when the second neuron is activated and the first neuron is not activated.

13. The method of claim 1, wherein modifying the synaptic weights of the neural network by applying the simulated memory replay process to the neural network comprises:
modifying a respective synaptic weight to accumulate synaptic updates over all activations that are associated with the respective synaptic weight.

14. The method of claim 6, wherein transforming the neural network from the synaptic weight-modified SNN to the synaptic weight-modified CNN comprises:
removing the simulated membrane potentials from the neural network;
removing the layer-wise scale factors from the neural network; and
replacing the Heavyside function with the original activation function for the neural network.

15. A system comprising:
one or more processors; and
memory storing machine-readable instructions that, when executed by the one or more processors, cause the system to:
transform a neural network from a convolutional neural network (CNN) to a spiking neural network (SNN);
when the neural network is transformed into the SNN, modify synaptic weights of the neural network by applying a simulated memory replay process to the neural network, wherein modifying the synaptic weights of the neural network by applying the simulated memory replay process to the neural network comprises applying a randomly distributed spiking input to the neural network and applying Hebbian-based learning rules to modify the synaptic weights; and
after applying the simulated memory replay process to the neural network, transform the neural network from the synaptic weight-modified SNN to a synaptic weight-modified CNN.

16. The system of claim 15, wherein the randomly distributed spiking input comprises a randomly distributed Poisson spiking input with firing rates determined by average values of each input pixel of a training dataset.

17. The system of claim 15, wherein the Hebbian-based learning rules comprise:
increasing a respective synaptic weight connecting a first neuron to a second neuron when both the first and second neuron are activated, wherein the first neuron is a pre-synaptic connection into the respective synaptic weight and the second neuron is a post-synaptic connection from the respective synaptic weight; and
decreasing the respective synaptic weight when the second neuron is activated and the first neuron is not activated.

18. The system of claim 15, wherein transforming the neural network from the CNN to the SNN comprises:
simulating a membrane potential for a respective neuron of the neural network; and
replacing an original activation function of the neural network with a Heaviside function to facilitate spikes such that when the simulated membrane potential of the respective neuron surpasses a pre-determined threshold, the respective neuron emits a spike.

19. The system of claim 18, wherein the simulated membrane potential for the respective neuron comprises a voltage reflecting a running sum of inputs determined by synaptic activity preceding the respective neuron in the neural network combined with synaptic weights preceding the respective neuron in the neural network.

20. The system of claim 19, wherein the simulated membrane potential for the respective neuron is subject to decay to simulate dynamics of a leaky integrate and neuron fire.
